(19) United States
(12) Patent Application Publication
(10) Pub. No.: US 2018/0331574 A1
(43) Pub. Date: Nov. 15, 2018

(54) VERTICAL POWER TRANSMISSION TYPE WIRELESS POWER TRANSMISSION AND CHARGING DEVICE

(71) Applicant: MIRO CO., LTD., Incheon (KR)

(72) Inventor: Dong Jin SEO, Incheon (KR)

(21) Appl. No.: 15/771,289

(22) PCT Filed: Oct. 26, 2016
(86) PCT No.: PCT/KR2016/012049

§ 371 Date: Apr. 26, 2018

(30) Foreign Application Priority Data
Oct. 26, 2015 (KR) 10-2015-0149024

(51) Int. Cl. H02J 50/12; H02J 50/70; H02J 7/02

(52) U.S. Cl. CPC H02J 50/12; H02J 7/02; H02J 50/70

(57) ABSTRACT

An apparatus for wirelessly transmitting and charging electric power using a vertical power transmission scheme according to an embodiment of the present disclosure includes a wireless power transmitting unit including a substrate and a vertical structure vertically arranged on the substrate, and configured to transmit electric power in a magnetic induction method through the substrate and the vertical structure, and a plurality of wireless power receiving units having vertically penetrated couplers, fitted in the vertical structure through the couplers to have a stacked structure, and configured to convert a magnetic force induced by the wireless power transmitting unit into an electric field to convert the electric field into electric power.

### TECHNICAL FIELD

Embodiments of the present disclosure relate to a wireless power transmission technology, and more particularly, to an apparatus for wirelessly transmitting and charging electric power using a vertical power transmission scheme.

### BACKGROUND ART

In recent years, preference of a user for a portable electronic device has increased, and such a portable electronic device has been an essential element for providing a ubiquitous environment to the user.

Meanwhile, currently, a battery charging scheme using a charger has mostly been used to supply electric power to the portable electronic device. In this case, there is a problem in that a separate charger should be provided to charge the portable electronic device, and accordingly, a wireless charging technology has been studied in which electric power is wirelessly provided regardless of whether the user possesses the charger, to charge a battery.

The wireless charging technology may be roughly classified into a magnetic induction method, a magnetic resonance method, and an electromagnetic wave method.

The magnetic induction method is a method in which a transmitter generates an alternating magnetic field, and through this, a receiver induces a current according to a change in the magnetic field, so that energy is generated.

The magnetic resonance method is a method in which a transmitter converts electric power into a resonating electromagnetic field and transmits the resonating electromagnetic field, and a receiver receives the electric power using a resonant coil having the same resonant frequency.

Finally, the electromagnetic wave (RF) method is a method in which electric energy is converted into a microwave that is advantageous for wireless transmission, and the energy is transmitted.

Among them, the magnetic induction method has been mainly used as a short-range wireless power transmission method. However, there is a problem in that since a magnetic wave generated by the transmitter may not be properly transmitted to the receiver, wireless electric power transmission efficiency deteriorates.

In particular, both the magnetic induction method and the magnetic resonance method may be used only when a distance is short, and efficiency deteriorates in the case of stacking. As a distance between a transmitter and a receiver becomes shorter, efficiency becomes higher. On the other hand, when the distance becomes larger, efficiency is also lowered, and a large amount of electromagnetic waves are radiated to the outside.

Accordingly, it is necessary to develop a technology that may stably and wirelessly supply electric power even in the case of stacking.

Korean Patent No. 10-1369157 (Title of Invention: wireless power transmitting device using magnetic induction) is disclosed as the related prior art.

### DISCLOSURE

### Technical Problem

The present disclosure provides an apparatus for wirelessly transmitting and charging electric power using a vertical power transmission scheme, in which a plurality of wireless power receiving units is fitted in a vertical structure of a wireless power transmitting unit and are arranged in a stacked structure, so that an interval between the wireless power transmitting unit and the wireless power receiving units may be maintained very narrow, the risk of electromagnetic waves may be minimized due to the stacked structure, and electric power may be simultaneously and efficiently transmitted to the plurality of wireless power receiving units.

Problems of the present disclosure are not limited to the above-described problem(s), and other not-described problems could be clearly understood by those skilled in the art with reference to the following descriptions.

### Technical Solution

An apparatus for wirelessly transmitting and charging electric power using a vertical power transmission scheme according to an embodiment of the present disclosure may include a wireless power transmitting unit including a substrate and a vertical structure vertically arranged on the substrate, and configured to transmit electric power in a magnetic induction method through the substrate and the vertical structure, and a plurality of wireless power receiving units having vertically penetrated couplers, fitted in the vertical structure through the couplers to have a stacked structure, and configured to convert a magnetic force induced by the wireless power transmitting unit into an electric field and convert the electric field into electric power.

The substrate may be a printed circuit board (PCB) circuit board connected to a power supply line through which the electric power is supplied and configured to receive the electric power to generate a frequency.

The vertical structure may have a coil formed in the vertical structure in a spiral shape and connected to the PCB circuit board, and may generate a frequency in a magnetic induction method by the coil to transmit the electric power.

The plurality of wireless power receiving units may have coils formed therein in a spiral shape, and may convert a magnetic force induced by the wireless power transmitting unit into an electric field through the coils to convert the electric field into electric power.

The plurality of wireless power receiving units may be vertically spaced apart from each other in a stacked structure.

The vertical structure may have a cross section of any one of a circle and polygons including a triangle and a quadrangle.

The couplers may have any one shape of a circle and polygons including a triangle and a quadrangle.

The plurality of wireless power receiving units may charge the converted electric power.

At least one of the wireless power transmitting units and the plurality of wireless power receiving units may include a light emitting circuit such that the apparatus is used as a light.

The apparatus may be waterproofed to be used as a waterproof product.

Detailed matters of other embodiments are included in the detailed description and the accompanying drawings.

### Advantageous Effects

According to an embodiment of the present disclosure, a current is applied to a coil embedded in a vertical structure of a wireless power transmitting unit to generate a magnetic field through a magnetic induction method, and an induced electromotive force is generated in coils embedded in wireless power receiving units by the medium of the generated magnetic field, so that transmission efficiency between the wireless power transmitting unit and the wireless power receiving units may increase.

According to the embodiment of the present disclosure, a plurality of wireless power receiving units is fitted in a vertical structure of a wireless power transmitting unit and are arranged in a stacked structure, so that an interval between the wireless power transmitting unit and the wireless power receiving units may be maintained very narrow, the risk of electromagnetic waves may be minimized due to the stacked structure, and electric power may be simultaneously and efficiently transmitted to the plurality of wireless power receiving units.

### DESCRIPTION OF DRAWINGS

FIG. 1 is an exploded perspective view illustrating an apparatus for wirelessly transmitting and charging electric power using a vertical power transmission scheme according to an embodiment of the present disclosure;

FIG. 2 is a combined perspective view illustrating an apparatus for wirelessly transmitting and charging electric power using a vertical power transmission scheme according to the embodiment of the present disclosure;

FIG. 3 is a view illustrating a wireless power transmitting unit of FIGS. 1 and 2 in detail; and

FIG. 4 is a view illustrating a wireless power receiving unit of FIGS. 1 and 2 in detail.

### BEST MODE

Advantages and/or features of the present disclosure and methods for achieving the advantages and/or the features will be clearly described with reference to embodiments which will be described below in detail together with the drawings. However, the present disclosure is not limited to the following embodiments but is implemented in various different forms. The present embodiments merely make the present disclosure complete, and are provided to completely notify those skilled in the art to which the present disclosure pertains of the scope of the present disclosure. Further, the present disclosure is merely defined by the scope of the appended claims. Throughout the specification, the same components are designated by the same reference numerals.

Hereinafter, embodiments of the present disclosure will be described in detail with reference to the accompanying drawings.

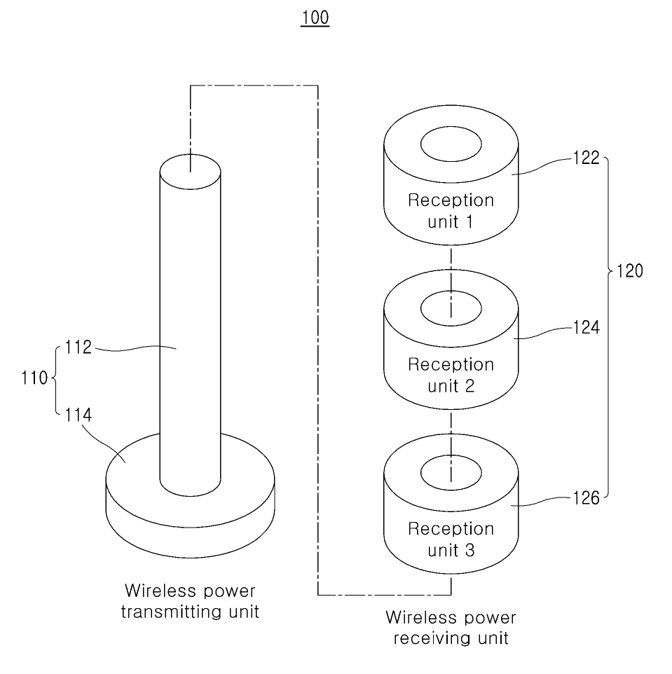

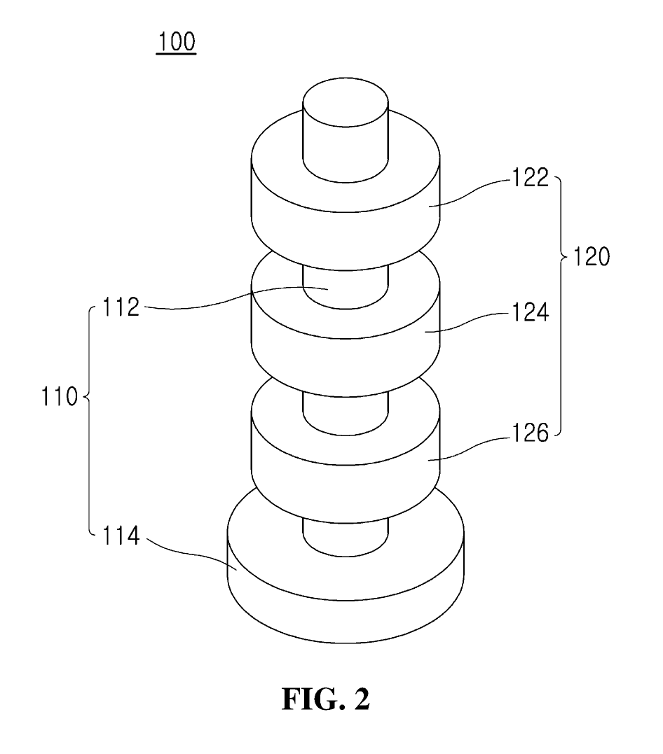

FIG. 1 is an exploded perspective view illustrating an apparatus for wirelessly transmitting and charging electric power using a vertical power transmission scheme according to an embodiment of the present disclosure, and FIG. 2 is a combined perspective view illustrating an apparatus for wirelessly transmitting and charging electric power using a vertical power transmission scheme according to the embodiment of the present disclosure.

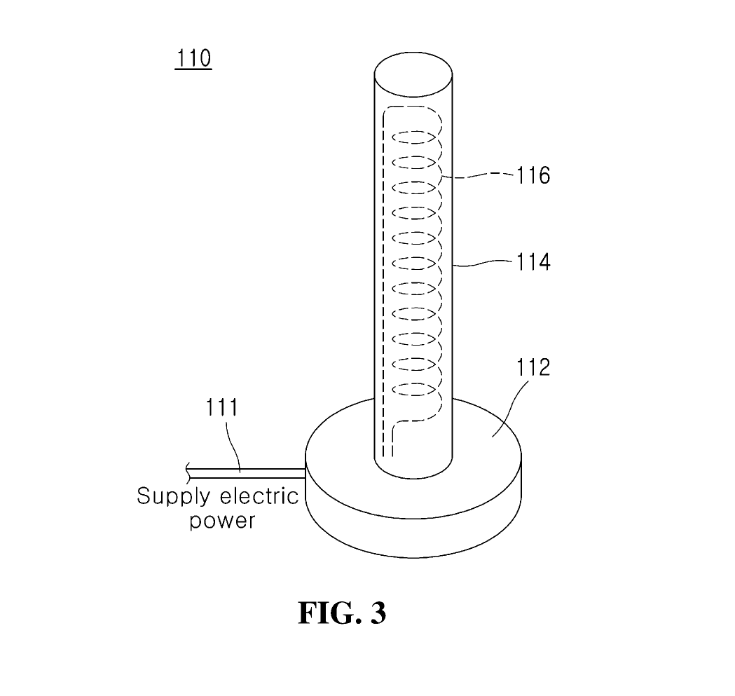

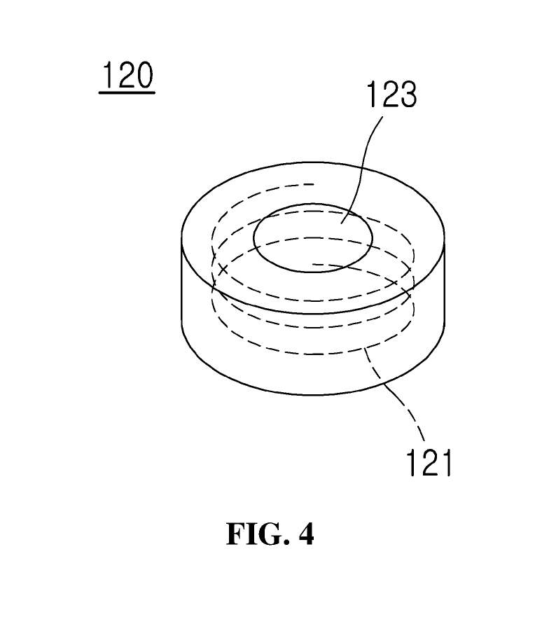

Also, FIG. 3 is a view illustrating a wireless power transmitting unit of FIGS. 1 and 2 in detail, and FIG. 4 is a view illustrating a wireless power receiving unit of FIGS. 1 and 2 in detail.

As illustrated in FIGS. 1 to 4, an apparatus 100 for wirelessly transmitting and charging electric power using a vertical power transmission scheme according to an embodiment of the present disclosure includes a wireless power transmitting unit 110 and wireless power receiving units 120.

The wireless power transmitting unit 110 includes a substrate 114 and a vertical structure 112 vertically arranged on the substrate 114. The wireless power transmitting unit 110 transmits electric power through the substrate 114 and the vertical structure 112 in a magnetic induction method.

Here, the substrate 114 may be implemented in a printed circuit board (PCB) circuit board that is connected to a power supply line 111 through which the electric power is supplied, and receives the electric power through the power supply line 111 to generate a frequency.

That is, the substrate 114 implemented in the PCB circuit board may receive the electric power through the power supply line 111 to transmit the electric power to the vertical structure 112.

The vertical structure 112 may have a coil 116 formed therein in a spiral shape and connected to the PCB circuit board.

At this time, the coil 116 may extend in a lengthwise direction of the vertical structure 112, that is, in a vertical direction. This is for enabling all the wireless power receiving units 120 to smoothly receive the electric power even when the wireless power receiving units 120 are stacked on each other.

The vertical structure 112 may have a circular cross section, as illustrated in the drawings.

However, the vertical structure 112 is not limited thereto, and may have various cross-sectional shapes. For example, the vertical structure 112 may have a cross section of a polygon such as a triangle and a quadrangle.

The vertical structure 112 may generate a frequency in the magnetic induction method by the coil 116 and may transmit the electric power.

Here, the magnetic induction method is a method in which a current is applied to one of adjacent two coils to generate a magnetic field, and an induced electromotive force is generated in the other coil by the medium of the generated magnetic field.

That is, in the embodiment of the present disclosure, a current is applied to the coil 116 embedded in the vertical structure 112 to generate a magnetic field, and an induced electromotive force may be generated in a coil 121 embedded in each of the wireless power receiving units 120 by the medium of the magnetic field generated in the coil 116.

Accordingly, according to the embodiment of the present disclosure, transmission efficiency between the wireless power transmitting unit 110 and the wireless power receiving units 120 may increase.

Hereinafter, the wireless power receiving units 120 that receive the electric power transmitted from the wireless power transmitting unit 110 through the magnetic induction method between the wireless power transmitting unit 110 and the wireless power receiving units 120 will be described in detail.

The wireless power receiving units 120 may be formed in a ring shape, and may include a plurality of reception units 122, 124, and 126.

That is, the wireless power receiving units 120 have vertically penetrated couplers 123, and are fitted in the vertical structure 112 through the couplers 123 to have a stacked structure.

Here, the couplers 123 may have a circular shape, as illustrated in the drawings.

However, the couplers 123 are not limited thereto, and may have various shapes. For example, the couplers 123 may have a shape of a polygon such as a triangle and a quadrangle.

The wireless power receiving units 120 convert a magnetic force induced by the wireless power transmitting unit 110 into an electric field and convert the electric field into electric power. To this end, the wireless power receiving units 120 may have coils 121 formed therein in a spiral shape.

The wireless power receiving units 120 may convert a magnetic force induced by the wireless power transmitting unit 110 into an electric field and may convert the electric field into electric power.

At this time, it is preferable that the wireless power receiving units 120 may have a stacked structure in which the plurality of reception units 122, 124, and 126 is vertically spaced apart from each other.

That is, in the wireless power receiving units 120, the plurality of reception units 122, 124, and 126 has the stacked structure, so that the electric power may be stably and wirelessly supplied.

In this way, in the embodiment of the present disclosure, the plurality of reception units 122, 124, and 126 constituting the wireless power receiving units 120 is fitted in the vertical structure 112 of the wireless power transmitting unit 110 and is thus arranged in the stacked structure.

Accordingly, according to the embodiment of the present disclosure, even while an interval between the wireless power transmitting unit 110 and the wireless power receiving units 120 is maintained very narrow, the stacked structure may be achieved, so that the electric power may be efficiently transmitted to the plurality of reception units 122, 124, and 126.

In this way, according to the embodiment of the present disclosure, since an interval between the wireless power transmitting unit 110 and the wireless power receiving units 120 may be minimized, the risk of electromagnetic waves may be minimized.

Also, according to the embodiment of the present disclosure, since the stacked structure may be achieved, the electric power may be simultaneously transmitted to the plurality of reception units 122, 124, and 126. This has an advantage in that the apparatus may be used directly for a wireless calling bell, and the like.

Also, according to the embodiment of the present disclosure, the electric power is wirelessly transmitted, so that a product may be operated using the electric energy without contact.

The wireless power receiving units 120 may charge the converted electric power. To this end, the wireless power receiving units 120 may have batteries.

Accordingly, even when the wireless power receiving units 120 fail to receive the electric power from the wireless power transmitting unit 110, the electric power charged in the battery is supplied to the corresponding product, so that the corresponding product may be operated.

Meanwhile, although not illustrated in the drawings, the apparatus 100 for wirelessly transmitting and charging electric power may be waterproofed to be used as a waterproof product.

That is, the wireless power transmitting unit 110 and the wireless power receiving units 120 constituting the apparatus 100 for wirelessly transmitting and charging electric power have an advantage in that since a portion exposed to the outside is greatly reduced due to a structure thereof, a waterproof structure may be easily applied.

Thus, the apparatus 100 for wirelessly transmitting and charging electric power may be applied to a commercial wireless calling bell and a small home appliance requiring waterproofing.

On the other hand, although not illustrated in the drawings, the apparatus 100 for wirelessly transmitting and charging electric power may include a light emitting circuit such that the apparatus 100 may be used as a light.

That is, at least one of the wireless power transmitting unit 110 and the wireless power receiving units 120 constituting the apparatus 110 for wirelessly transmitting and charging electric power may include a light emitting circuit such that the apparatus 100 may be used as a light.

Although the detailed embodiments of the present disclosure have been described until now, it is apparent that various modifications may be conceived without departing from the scope of the present disclosure. Therefore, the scope of the present disclosure is not limited to the described embodiments, and should be defined by the scope of the appended claims and equivalents to the scope of the appended claims.

Although the present disclosure has been described with reference to the delimited embodiments and the drawings as above, the present disclosure is not limited to the above-described embodiments. Various modifications and changes may be conceived by those skilled in the art to which the present disclosure pertains from the description. Thus, the spirit of the present disclosure should be determined only by the appended claims, and all equivalents and variations belong to the scope of the spirit of the present disclosure.

1. An apparatus for wirelessly transmitting and charging electric power using a vertical power transmission scheme, the apparatus comprising:
a wireless power transmitting unit including a substrate and a vertical structure vertically arranged on the substrate, and configured to transmit electric power in a magnetic induction method through the substrate and the vertical structure; and
a plurality of wireless power receiving units having vertically penetrated couplers, fitted in the vertical structure through the couplers to have a stacked structure, and configured to convert a magnetic force induced by the wireless power transmitting unit into an electric field and convert the electric field into electric power.

2. The apparatus of claim 1, wherein the substrate is a printed circuit board (PCB) circuit board connected to a power supply line through which the electric power is supplied and configured to receive the electric power to generate a frequency.

3. The apparatus of claim 2, wherein the vertical structure has a coil formed in the vertical structure in a spiral shape and connected to the PCB circuit board, and generates a frequency in a magnetic induction method by the coil to transmit the electric power.

4. The apparatus of claim 1, wherein the plurality of wireless power receiving units has coils formed in the wireless power receiving units in a spiral shape, and convert a magnetic force induced by the wireless power transmitting unit into an electric field through the coils to convert the electric field into electric power.

5. The apparatus of claim 1, wherein the plurality of wireless power receiving units is vertically spaced apart from each other in a stacked structure.

6. The apparatus of claim 1, wherein the vertical structure has a cross section of any one of a circle and polygons including a triangle and a quadrangle.

7. The apparatus of claim 1, wherein the couplers have any one shape of a circle and polygons including a triangle and a quadrangle.

8. The apparatus of claim 1, wherein the plurality of wireless power receiving units charges the converted electric power.

9. The apparatus of claim 1, wherein at least one of the wireless power transmitting unit and the plurality of wireless power receiving units includes a light emitting circuit such that the apparatus is used as a light.

10. The apparatus of claim 1, wherein the apparatus is waterproofed to be used as a waterproof product.
